(19) United States
(12) Patent Application Publication
(10) Pub. No.: US 2026/0060178 A1
(43) Pub. Date: Mar. 5, 2026

(54) MOBILE HOP HARVESTER AND PROCESSOR

(71) Applicant: Segal Ranch, LLC, Grandview, WA (US)

(72) Inventor: Martin S. Ramos, Grandview, WA (US)

(21) Appl. No.: 18/823,668

(22) Filed: Sep. 3, 2024

(51) Int. Cl. A01D 46/02; A01D 57/16; A01D 61/00

(52) U.S. Cl. CPC A01D 46/02; A01D 57/16; A01D 61/008

(57) ABSTRACT

A mobile hop harvester including a tilt-able cutting tower that can be lowered to move into the hop yard, and then raised to the full height of a trellis to top and bottom cut, and segment hop bines. The segmented bines fall through the tilted cutting tower and are moved upward and reward on a bine conveyor into a picking array that includes parallel series of rotating top retarders positioned over a parallel series of bottom picker fingers, each mounted on parallel spools or rollers, moving the cones, bines and debris forward through the processor at a downward incline, keeping the residual bines, leaves, twine, and debris engaged for ejection from the front or towed end of the processor, while allowing the hop cones to fall onto a cone conveyor upward out the rear of the processor for collection into a bin or the bed of a tending truck.

### TECHNICAL FIELD

The present disclosure to a method and apparatus for harvesting and processing of hops in the field, and more particularly to a mobile harvester and processor, or simply a “hop harvester”. More specifically, a cutting tower of the hop harvester cuts hop “bines”, into manageable segments and a picking array separates and collects the hop cones. The hop harvester may be either self-propelled or tow-able, and operates to autonomously cut, section, rake, strip, and collect the hop cones from the trellised bines.

### BACKGROUND OF THE INVENTION

Rising farm labor costs and a decrease in available workers willing to perform traditionally low paying harvesting tasks has forced many growers to turn to automation. In the long term, mechanical automations have the potential to increase profits and keep farming operations economically viable, even with increased labor costs, while improving opportunities for technically skilled agricultural laborers. Though often a significant capital investment, it is becoming more desirable to supplement or replace certain labor intensive farming operations by automated processes.

To remain viable, the agricultural industry must develop automated solutions that utilize technological improvements to reduce the labor required to accomplish required harvesting and processing tasks safely and economically. Any new mechanism or apparatus with methods that serve well in aiding the harvesting and processing of crops and plantings while reducing the number of workers required to perform required operations has potential for useful service.

The automation of harvesting and processing hops in the field is difficult, primarily due to the nature of the vertically growing hop vines, more properly referred to as “bines”. These bines are grown in trellised “hop yards” and typically harvested by manually cutting the vine away from the high, top wires of the trellis. Conventionally, the cut bines are then brought into a processing facility and individually re-strung upon hooks. There, the bines are stripped of their cones and typically the cones are then dried, or further processed as needed, with the residual bines, including stems and leaves discarded or recycled as compost.

Again, hop harvesting conventionally requires laborers to both harvest the individual bines for transport and then to place the bines on hangers or hooks in the processing plant for further process steps, including the stripping of the cones from the bines. Several machines and automated processors have been developed to aid in hop harvesting and processing, but these prior devices typically only address single harvesting or processing steps and fall short of providing a complete harvesting and processing system. An all-encompassing method and apparatus to reduce the labor required to both harvest and process hops would be well received in the field of hop harvesting and processing.

Therefore, the present invention as disclosed herein addresses these needs for improved hop harvesting and processing, with inventive features that will be better understood by reference to the following detailed description taken in conjunction with the accompanying drawings.

### BRIEF DESCRIPTION OF THE DRAWINGS

Exemplary embodiments of the present invention will become more fully apparent from the following descriptions and appended claims, taken in conjunction with the accompanying drawings. Understanding that these drawings depict only exemplary embodiments and are, therefore, not to be considered limiting of the scope of the present invention, with the exemplary embodiments described with additional specificity and detail through use of the accompanying drawings in which:

FIG. 1 is a side view of a mobile hop harvester and processor, according to an embodiment of the invention;

FIG. 2 is a side view of a mobile hop harvester and processor, according to an embodiment of the invention;

FIG. 3 is a side view of a mobile hop harvester and processor, according to an embodiment of the invention;

FIG. 4 is a side view of a mobile hop harvester and processor, according to an embodiment of the invention;

FIG. 5 is a front view of a mobile hop harvester and processor, according to an embodiment of the invention; and

FIG. 6 is a perspective view of a portion of a mobile hop harvester and processor, according to an embodiment of the invention.

Reference characters included in the above drawings indicate corresponding parts throughout the several views, as discussed herein. The description herein illustrates one preferred embodiment of the invention, in one form, and the description herein is not to be construed as limiting the scope of the invention in any manner. It should be understood that the above listed figures are not necessarily to scale and may include fragmentary views, graphic symbols, diagrammatic or schematic representations. Details that are not necessary for an understanding of the present invention by one skilled in the technology of the invention, or render other details difficult to perceive, may have been omitted.

### DETAILED DESCRIPTION OF SPECIFIC EMBODIMENTS

The present disclosure relates to and is applicable to a mobile hop harvester and processor apparatus that cuts hop “bines” into manageable segments, supplemented by a picking array for separating and collecting the harvested hop cones. The mobile hop harvester and processor apparatus may be either self-propelled or tow-able, and operates to autonomously cut, section, rake, strip, and collect the hop cones from the trellised bines. Also, the mobile hop harvester and processor apparatus, may be referred to herein more simply as the “hop harvester”.

The operational steps and apparatus elements employed in the hop harvester, as described and illustrated herein, could be executed, arranged, and designed in a variety of different configurations or order of operation. Thus, the following detailed description of the embodiments of the hop harvester of the present invention with the preferred elements of its apparatus and its operation are not intended to limit the scope of the invention, as claimed, but merely representative of exemplary embodiments of the technology. With the present disclosure and technical description of the hop harvester provided herein by way of example, it also should be noted that other similar configurations and components could be utilized in alternative embodiments of elements of the hop harvester of the present invention and in alternative operational steps. Therefore, exemplary embodiments of the hop harvester and its operation will be best understood by reference to the drawings included herewith, with like parts designated by like numerals throughout.

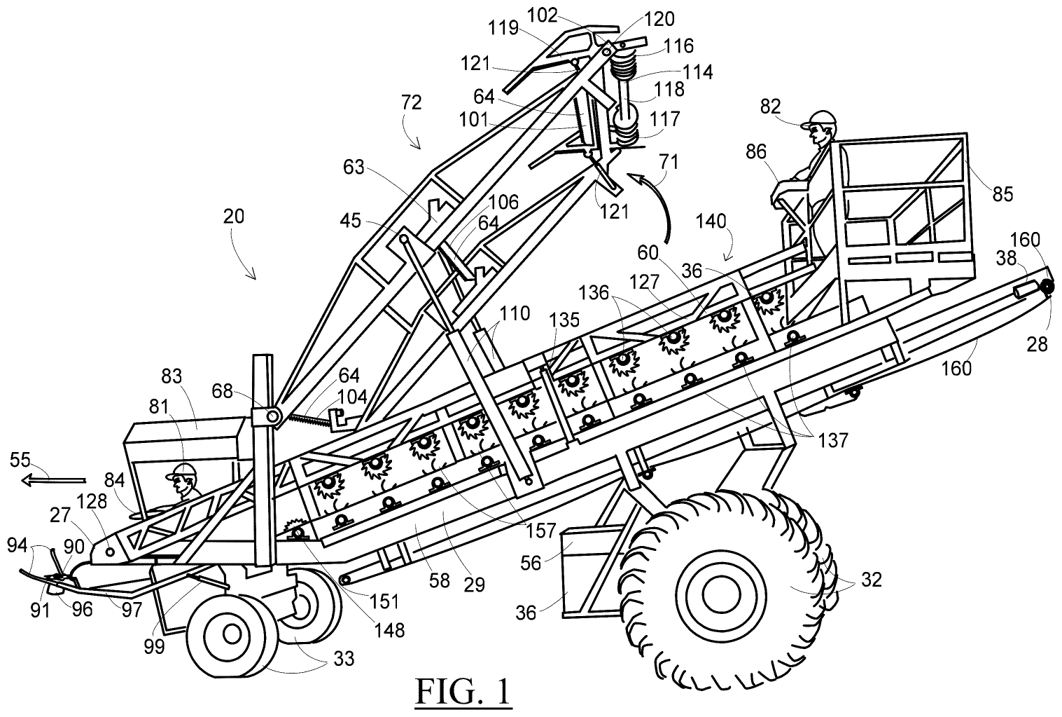

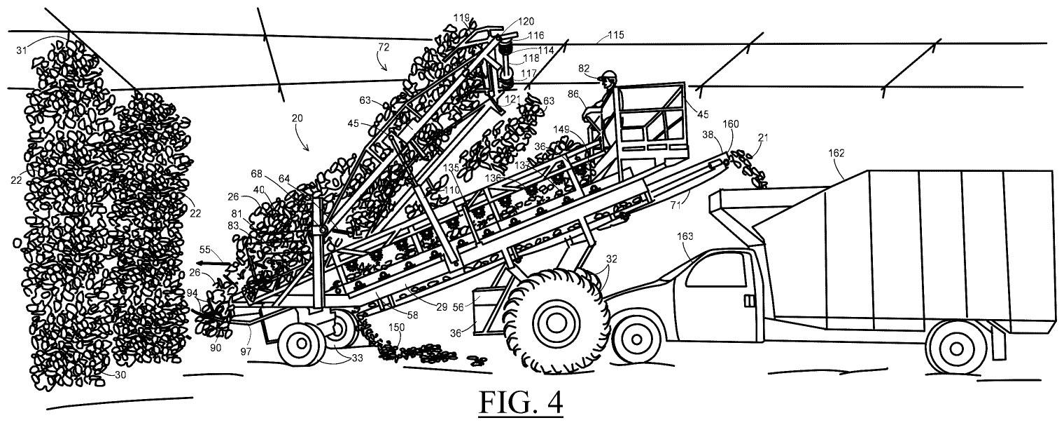

The present invention provides for a hop harvester 20, with FIGS. 1 through 6 showing aspects of a preferred embodiment of the hop harvester, as employed to harvest and process hop cones 21 as produced by a hop plant 22, in the mature growing stage of the hop plant as conventionally grown in a hop yard 23. The “hop yard” is broadly defined as any area in which the hop plants are cultivated, grown, and processed for harvesting, typically on a trellis 25, as shown in FIG. 4. Conventionally, the “hop plant” is generally defined as any variation or cultivar of the plant Humulus lupulus, from which the product hop cones are produced.

“Hop cones” 21 as produced by the mature hop plant 22 may be more simply referred to herein as “hops” or “cones”. For the present specification, including the drawings and appended claims, “hops” are broadly defined to incorporate not only the above definitions, but the hop harvester 20 of the present invention may be applied to the harvesting and processing of any hop-like plant. The cones of the hop plant are an essential flavoring component of beer beverages, and the cones are produced by the hop plant from the vine-like appendages commonly referred to as a bine 26. The trellis includes vertical strings 35, with the bines typically growing upward and twisting about the vertical strings of the trellis 25, from a plant base 30 up to a plant top 31, as shown in FIG. 4. The vertical strings are typically made from a natural twine material with good tensile strength, but easily cut in the harvesting operation.

As shown in FIGS. 1 through 3, the hop harvester 20 includes a forward end 27 and a rearward end 28. Structurally, the hop harvester has a main chassis 29 that is mobile, with a pair of forward wheels 32 proximate to the forward end 27 of the hop harvester, and a pair of drive wheels 33 preferably located forward of the rearward end 28 of the hop harvester relative to the pair of forward wheels. The forward end of the hop harvester may be simply referred to as “forward” herein, to denote an element of the hop harvester located proximate to the forward end of the hop harvester, or to denote a movement toward the forward end of the hop harvester. Likewise, rearward end 28 of the hop harvester may be simply referred to as “rearward” herein, to denote an element of the hop harvester located proximate to the rearward end of the hop harvester, or to denote a movement toward the rearward end of the hop harvester.

The hop harvester 20 is mobile and may be towed, but as preferred the hop harvester travels as a self-propelled apparatus along a ground surface 53. In the most preferred method of operation, the hop harvester moves in a forward travel direction 55, preferably self-powered by an engine 56 that transmits rotational power to the drive wheels. The engine of the hop harvester may be a conventional gasoline, diesel, propane, electric motor, or equivalent alternative, as could be utilized in a farming or agricultural setting. Preferably, the engine of the hop harvester is positioned beneath the main chassis 29 between the pair of drive wheels 32, as shown in FIGS. 1 through 4.

Alternatively, the hop harvester 20 could be towed or pushed by a tractor having a conventional “power take-off” or “PTO” mechanism, to provide rotational power to meet the drive and actuation needs of the hop harvester. The tractor, if used to either push or more preferably to tow the hop harvester, could be in the alternative form of any farm, orchard, and vineyard or hop yard vehicle, as known to those skilled in the selection and use of agricultural vehicles.

As preferred, the engine 36 of the hop harvester 20, or alternatively the PTO provided by the towing tractor or vehicle to the hop harvester, also powers a hydraulic system 56 including or alternatively in addition to the pair of drive wheels 33. The hydraulic system, as is well known to persons skilled in hydraulic system engineering, serves to provide a pressurized hydraulic fluid through high pressure hoses or pipes, to power the various actuators, conveyors, and spinning, turning, and motor driven components of the hop harvester, including the power required to turn the pair of forward wheels 32 as needed to steer the hop harvester.

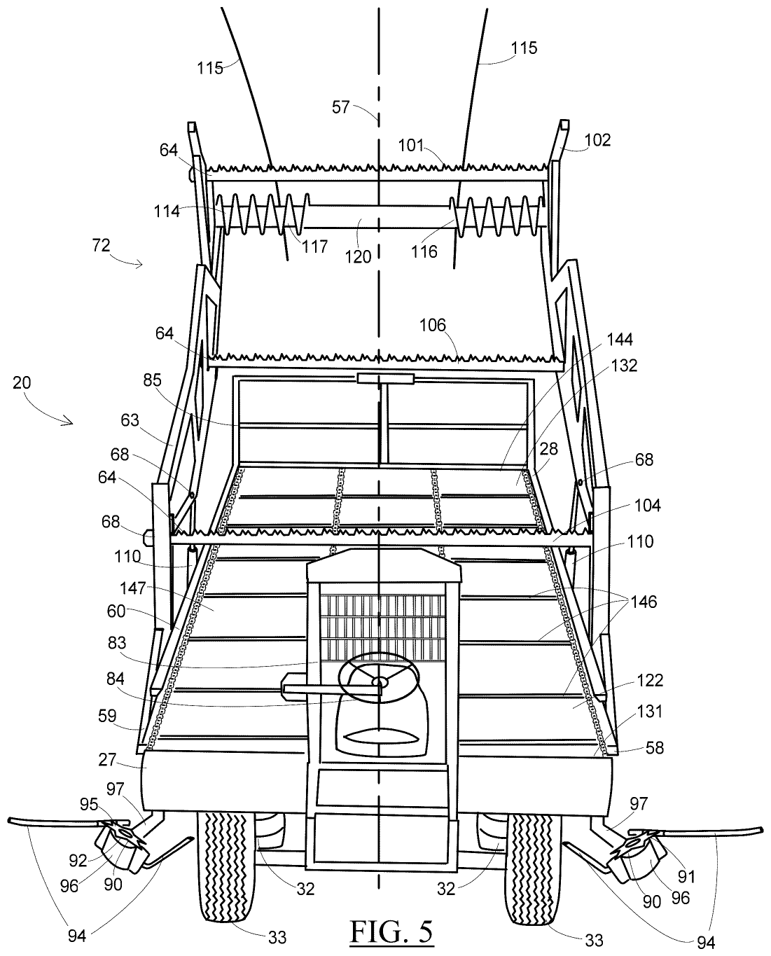

Also, the hop harvester 20 has sides located substantially in parallel to the forward travel direction 55, with a first side 58 to the right when facing the hop harvester from the forward end with the view of FIG. 5, and a second side 59 to the left when facing the hop harvester from the forward end with the view also of FIG. 5. Additionally, the hop harvester 20 has a centerline 57 located substantially in parallel to the forward travel direction, and mid-way between the first side and the second side as shown in FIG. 5.

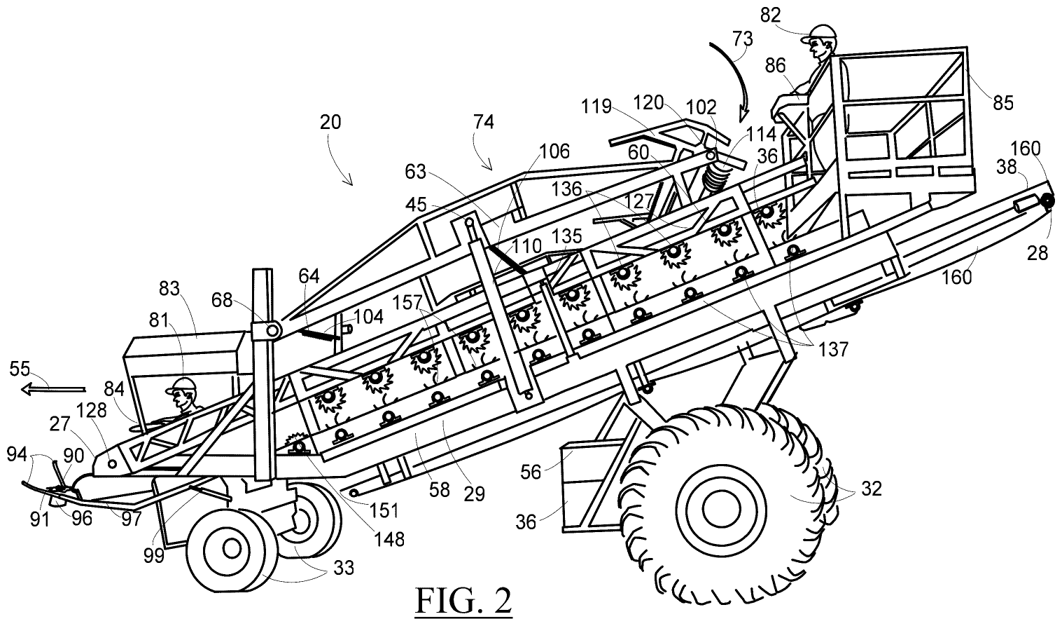

The main chassis 29 of the hop harvester 20 supports a bine processing table 60 for conveying and picking the cones from the bines received into the hop harvester. Additionally, the hop harvester includes a cutting tower 63 that extends upwardly from the main chassis 31. The cutting tower includes a multiple of reciprocating cutters 64 for mechanically cutting the bines from the trellises. The cutting tower is tilt-able about a tower pivot 68, with the tower pivot preferably located on the main chassis, proximate to the forward end of the hop harvester. As shown in FIG. 1, the cutting tower can be tilted upward and forward in a tower raising movement 71 about the tower pivot, to raise the cutting tower up to a raised tower position 72. In the raised tower position, the cutting tower is at the full height of the trellis 25 in the hop yard 23, and can be positioned in close proximity to the plant top 31 of the hop plant 22. Also, the cutting tower can be tilted downward to the rear in a tower lowering movement 73 about the tower pivot, to lower the cutting tower down in a stowed tower position 74. In the stowed tower position, the cutting tower rests on the bine processing section 35, as shown in FIG. 2.

A significant advantage of the hop process 20 of the present invention is the ability of the hop processor to travel within the hop yard 23 or between hop yards with the cutting tower 63 in the stowed tower position 74. With the cutting tower in the stowed tower position the traveling hop harvester is able to clear beneath any overhead obstacles typically present, including electrical wires, low warehouse structures, underpasses or bridges, irrigation piping, trellis lines, and the like.

Preferably, operational control of the hop harvester 20 is accomplished manually by an operator. In a preferred embodiment of the hop harvester, two operators are employed. As shown in FIGS. 1 through 3, a forward operator 81 is positioned proximate to the forward end 27 of the hop harvester, and a rearward operator 82 is positioned proximate to the rearward end 28 of the hop harvester. In the preferred embodiment of the hop harvester, the forward operator is seated within a forward cab 83, and steers the pair of forward wheels 33 with a steering wheel 84, as shown in FIG. 5. The forward operator guides the hop harvester through the hop yard 23.

The rearward operator 82 preferably stands within a rearward platform 85 proximate to the rearward end 28 of the hop harvester 20. In the preferred embodiment of the hop harvester, the rearward operator uses a rearward control panel 86 to monitor and control the operational position and processing systems and components of the both the cutting tower 63 and the bine processing table 60 of the hop harvester, as discussed in further detail later herein.

In a preferred embodiment of the hop harvester of the present invention, a pair of outboard cutters 90 is utilized to assist the hop harvester in cutting each hop plant 22 as encountered on the trellises 22 of the hop yard 23 at the forward end 27 of the hop harvester. As shown in FIG. 5, a first outboard cutter 91 can be mounted proximate to the first side 58 of the hop harvester near the forward end, and a second outboard cutter 92 can be mounted proximate to the second side 59 of the hop harvester, also near the forward end. Each outboard cutter includes a pair of fender rods 93 that serve to guide the bines 26 into a spinning rotor blade 95 mounted on an outboard blade motor 96, of each outboard cutter, with each outboard blade motor attached to an outboard arm 97 that extends from an outboard cutter pivot 98. Preferably, each outdoor cutter pivot is attached to the main chassis 29, again proximate to the forward end of the hop harvester, with an outboard cutter actuator 99 connecting the main chassis and the outboard cutter arm.

The pair of outboard cutters 90 are individually positioned to sever the hop bine 26 proximate to the plant base 30 of the hop plant 22, as shown in FIG. 4. Most preferably each of the pair of outboard cutters are operated and positioned with use of a conventional “joystick” type of controller, under the control of the forward operator 81. As preferred, the pair of hop cutters are configured to process two side-by-side hop bines simultaneously as a pair, with a first hop bine cut and processed toward the first side 58 of the hop harvester and a second hop bine cut and processed toward the second side 59 of the hop harvester, and with the forward cab 83 housing the forward operator 81 positioned between the first cut hop bine and the second cut hop bine as shown in from the side in FIG. 4, at a center line 57 of the hop processor, as shown from the front in FIG. 5.

The cutting tower 36 serves to cut the vertical strings 35 of the trellis 25 and the bines 26, so that the bines are cut into a multiple of bine segments 100 or simply referred to herein as the “bine segments”, with the bine segments received into the bine processing table 60 of the hop harvester 20. The multiple of cutters on the cutting tower, include a top-beam cutter 101 located proximate to the highest point or an upper tower end 102 of the cutting tower, a lower-beam cutter 104 located proximate to the lowest portion of the cutting tower, proximate to the tower pivot 68, and a mid-beam cutter 106 located proximate to a mid-point 107 of the cutting tower and approximately half-way between the upper tower end and the tower pivot. The top-beam cutter, the mid-beam cutter, and the lower-beam cutter, along with the pair of outboard cutters 90 cut and section the hop bines received onto the cutting tower into the bine segments 100, as shown in FIG. 4.

To receive the entire bine 26 from the trellis 25 into the hop processor 20, from the bottom-cut made by the pair of outboard cutters 90 to the top-cut made by the top-beam cutter of the cutting tower 63, the cutting tower is tilted upwardly on the tower pivot 68 to raise the cutting tower up to the raised tower position 72. The cutting tower is raised and lowered with a pair of tower actuators 110, as shown in FIG. 5. The tower actuators most preferably include conventional, double acting hydraulic pistons powered by the hydraulic system 56 of the hop processor and controlled by the rearward operator 82.

Most preferably, to better collect the bine segments 100 from the hop plants 22 on each trellis 25, and also prevent the bine segments from spilling out of the hop harvester 20 after being cut, a bine auger 114 is positioned proximate to the upper tower end 102 of the cutting tower 63 to the rearward of the top-beam cutter 101, as shown in FIGS. 1 and 5. Each vertical string 35 of the trellis 25 is tied to an overhead parallel wire of the hop yard 23, which runs substantially in parallel to the forward travel direction 55 of the hop harvester. The overhead parallel wire may simply be referred to herein as a “top wire” 115.

The bine auger 114 is a spiraled attachment to the cutting tower 63 that serves to pull the top wires 115 toward the centerline 57 of the hop harvester along with the attached bine segments 100 on each vertical string 35 that hangs from the top wires of the trellis 25. Specifically, the bine auger directs the top wires received into the cutting tower inwardly and away from first side 58 and the second side 59 of the hop harvester, toward the centerline of the hop harvester 20. Specifically, the bine auger includes a first auger 116 proximate to the first side 58 of the hop harvester 20, which rotates to pull the engaged top wire from the first side, toward the centerline of the hop harvester, and a second auger 117 that rotates to pull the engaged top wire away from the second side 59 toward the centerline of the hop harvester. As shown in FIG. 5, the first auger 116 and the second auger 117 are placed on an auger shaft 118 that is common to the first auger and the second auger. Preferably, the first auger is counter-spiraled in relation to the second auger, so that when the auger shaft of the bine auger 114 rotates, the first auger and the second auger rotate together, to each pull the top wire and attached bine segments away from the respective first outer side and second outer side and to the centerline of the hop harvester.

Preferably, to control the height of the bine auger 114 relative to the overhead parallel wire 115 of the trellis 25, the bine auger is mounted on an auger frame 119 that can hinge on an auger pivot 120 on the cutting tower 63, as shown in FIG. 1. The auger frame can be raised or lowered by the rearward operator 82 with the use of a pair of auger frame actuators 121, which are hydraulic actuators of typical design as most preferred.

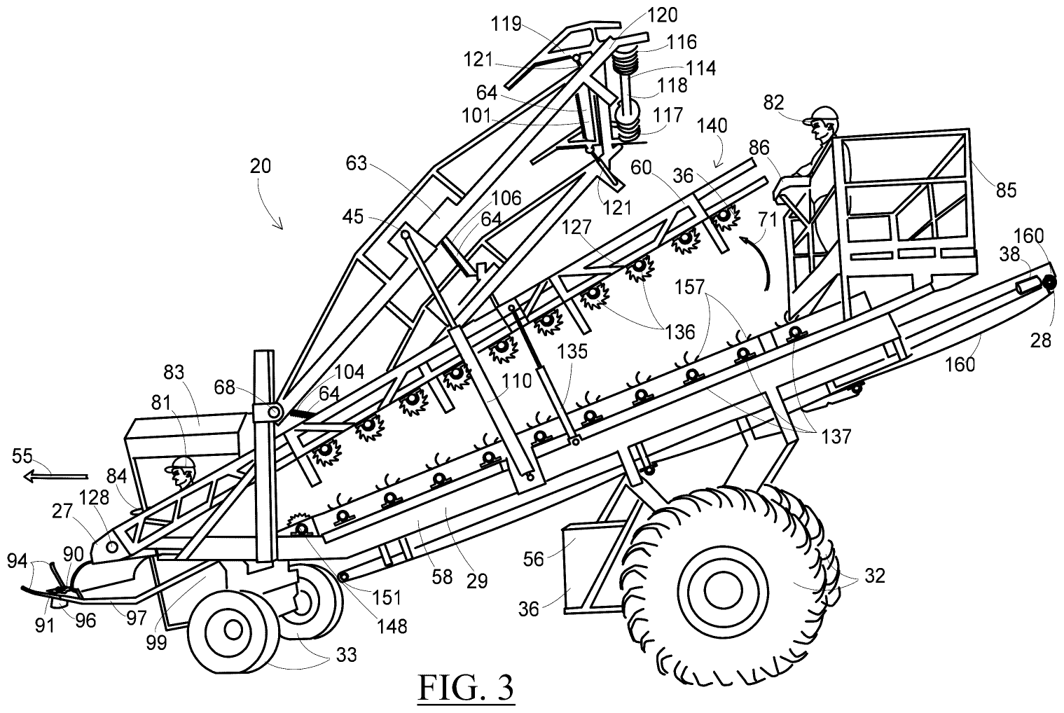

With aid of the bine auger 115, the bine segments 100 fall from the tilted cutting tower and onto a bine conveyor 122, on the bine processing table 60 below the cutting tower. Preferably, the bine processing table includes the bine conveyor supported on a retarder frame 127 and together with the retarder frame, the bine conveyor tilts on a table pivot 128 that is located proximate to the forward end 27 of the hop harvester 20, as shown in FIG. 3.

The bine conveyor 122 is inclined upward, at a preferred operational pitch of approximately twenty degrees from the ground surface 53 up toward the rearward end 28 of the hop harvester 20, with a lower bine conveyor end 131 proximate to the forward end 27 of the hop harvester and forward of the tower pivot 38. The bine conveyor inclines upward to an upper bine conveyor end 132 located proximate to the rearward end 28 of the hop harvester, as shown in FIG. 2. Preferably, the entire bine processing table 60, including the bine conveyor and the retarder frame can be raised or lowered on the bine conveyor pivot over a picker frame 133, upon the main chassis 29. The bine processing table can be tilted upwardly on the table pivot 128, to raise the upper bine conveyor end 132 of the bine processing table, lifting the bine processing table as shown in FIG. 3, to clear out any bine segments 100 held-up between the retarder frame and the picker frame.

The bine processing table 60 is raised and lowered with a pair of table actuators 135, as shown in FIG. 5. The table actuators most preferably include conventional, double acting hydraulic pistons powered by the hydraulic system 56 of the hop processor and controlled by the rearward operator 82. The retarder frame as included in the bine processing table, seats upon the picker frame 133, with the picker frame mounted on the main chassis 29 of the hop harvester 20.

The retarder frame 127 includes a multiple of retarder rollers 136, with each retarder roller mounted in series on retarder roller bearings 138. Similarly, the picker frame includes a multiple of picker rollers 137, with each picker roller also mounted in series on picker roller bearings 139.

Together, the retarder frame 127 with the multiple of retarder rollers 136 along with the picker frame 133 with the multiple of picker rollers 137 comprise a picking array 140 for the hop processor, as shown in FIG. 1. Operationally, the bine segments 100 produced by the cutting tower 63 fall to the bine conveyor 122, which transports the bine segments upward and to the upper bine conveyor end 132 to a bine conveyor discharge 144. Preferably, the bine conveyor includes a multiple of parallel conveyor flights 146 that stepwise travel upwardly upon a bine barrier 147. The bine barrier prevents the bine segments on the bine conveyor from falling into the picking array 140, before the bine segments reach the bine conveyor discharge. Instead, the bine segments cascade rearward and out of the bine conveyor at the upper bine conveyor end, at the bine conveyor discharge.

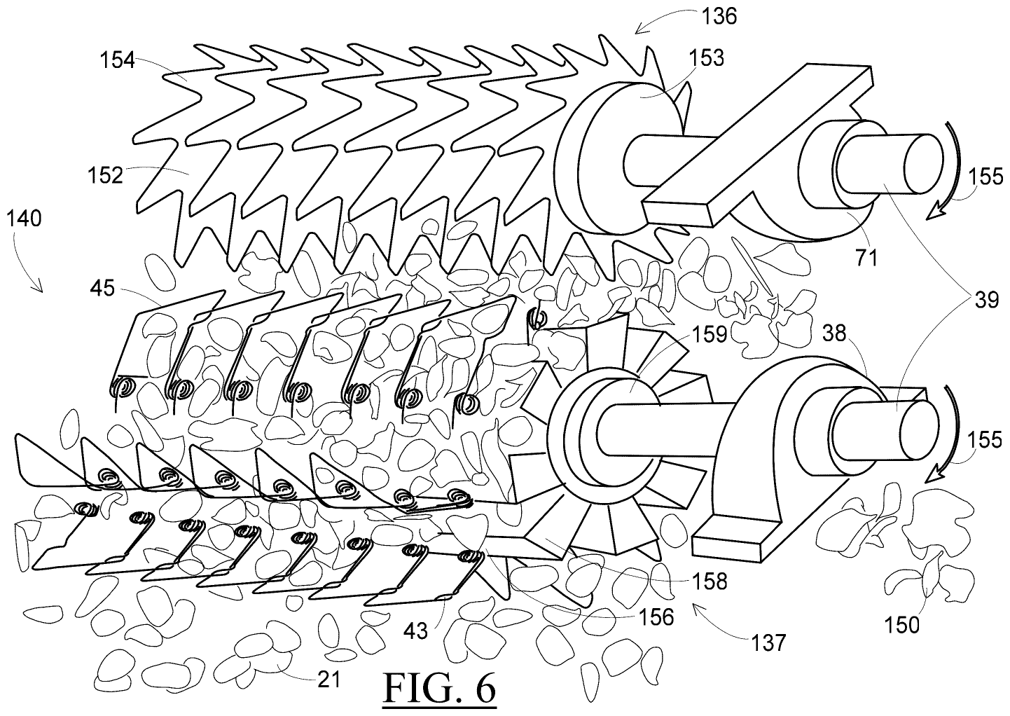

From the bine conveyor 122, the bine segments 100 are received into a bine picker infeed 149 of the picking array 140. Again, the picking array is shown in FIG. 1 and detailed in FIG. 6, with the multiple of picker rollers 137 positioned beneath the multiple of retarder rollers 136. The bine segments travel between the quickly rotating picker rollers and the slowly rotating retarder rollers, so that the hop cones 21 are picked from the bine segments and fall downward out of the picking array, while a residual debris 150 is retained between the retarding rollers and picker rollers and the residual debris is ejected from the picking array, between the picker roller and the retarder roller at a debris discharge 151, located proximate to the forward end 27 of the hop harvester 20, as shown in FIG. 4. The residual debris is substantially every element of the hop bine excluding the hop cones, which are the desired product of the hop harvester. Therefore the residual debris typically includes the leaves and bine stems for the bines, and, additionally debris can include trellis elements such as the twine or cordage of the vertical strings 35.

In an optional addition on the hop harvester 20, to better chop and mulch the residual debris 150, a debris chopping roller 148 can be included as shown in FIGS. 1 through 3. Preferably, the debris chopping roller is mounted within the picker frame 133 in line with the picker rollers, and at the debris discharge 151 proximate to the forward end 27 of the hop harvester. Most preferably, the debris chopping roller includes a set of radial saw blades mounted similarly to the retarder discs 152, and spin in the same direction of rotation as the picker rollers 137.

Each of the multiple of retarder rollers 136 includes a multiple of retarder discs 152 received onto a retarder spindle 153. Each retarding disc is star-shaped, with a multiple of retarder teeth 154 radiating outward from the retarder spindle, when the retarder discs are mounted along the retarder spindle, as shown in FIG. 6. Additionally, each of the multiple of picker rollers 137 includes a multiple of finger flights 156. Each finger flight is composed of a multiple of picker fingers 157 attached to a finger bar 158, and each finger flight mounts radially around a picker spindle 159, as shown in FIG. 6. Each finger flight mounts in parallel around the picker spindle, and the multiple of picker fingers, most preferably in the form of spring tines also as shown in FIG. 6, each radiate outward from the picker spindle.

The use and design of the retarder teeth 154 and of the picker fingers 157, as well as the design of picking arrays, discs, and flights or holders to mount the bine retarding teeth and the picking fingers on their respective retarder rollers 136 and picker rollers 137 are well known to those skilled in automated hop cone picking technologies, as used in the picking array 140 of the hop harvester 20. Additionally, although an optimal ratio of rotational speed for the picker rollers 137 in relation to the retarder rollers 136 is approximately 5-to-1, with a target rotational rate for the picker rollers of approximately sixty revolutions per minute. There are a multiple of configurations, arrangements, rate of operation, and element attachment alternatives for the bine teeth and picking fingers, also well known or readily apparent without undue experimentation to those skilled in automated hop cone picking that may result in similar efficiencies for hop cone removal from the bines, besides the preferred configuration and design employed in the detailed description herein.

Most preferably, each of the multiple of retarder rollers 136 co-rotates in a same direction of rotation 155 in relation to each of the multiple of picker rollers 137 as shown in FIG. 6, with the retarder rollers pulling the bine segments 100 upward along the incline of the picking array 140, toward the rearward end 28 of the hop harvester 20. Conversely, each picker roller pulls the bine segments downward along the incline of the picking array, toward the forward end 27 of the hop harvester, as shown in FIG. 6. With the multiple of picker fingers 157 quickly rotating on the picker rollers, the picking array 140 is very effective in stripping the hop cones 21 from the bine segments.

The hop cones 21 picked from the bines segments 100 by the picking array 140 fall downward out of the picking array to a cone conveyor 160 positioned beneath the picking array as shown in FIG. 4. The cone conveyor moves the cones upward and to the rearward end 28 of the hop processor 20, to a cone discharge 161, again at the preferred operational pitch of approximately twenty degrees from the ground surface 53. Most preferably, the cone discharge of the cone conveyor is positioned upward and over a cone collection bin 162. The cone collection bin can be any container, hopper, box or bin for receiving the cones. Most preferably, the cone collection bin is included in a tender truck 163 as shown in FIG. 4, with the tender truck able to fit between the pair of drive wheels 32 of the hop harvester. With the tender truck positioned beneath the cone conveyor, the cone discharge can deposit the cones directly into the cone collection bin.

As soon as the cone collection bin 162 is substantially filled, the operation of the cutting tower 63 and bine processing section 60 including the picking array 140 of the hop harvester 20 can be paused, while another tender truck 163 with an empty cone collection bin can be re-positioned below the cone discharge 161 of the cone conveyor 160.

It is observed that the number of people required to operate the hop harvester 20 according to the methods of the invention as depicted in FIGS. 1 through 6 may be greatly reduced from the number required for typical harvesting and processing crews. Additionally, the speed of harvesting and processing is greatly increased by the hop harvester of the present invention, especially when compared to conventional manual labor intensive harvesting operations. Additionally, it is well considered that instead of the preferred hydraulic system 56, the hop harvester of the present invention could employ an electric servo or an electric motor actuation system or possibly a pneumatic actuated system, in the alternative.

For this Detailed Description of Specific Embodiments, the terms “connected”, “attached”, “coupled” and “mounted” refer to any form of interaction between two or more elements, including mechanical, electrical, magnetic, electromagnetic, fluid, and thermal interaction. Two components may be functionally coupled with or to each other, even though they are not in direct contact with each other.

The word “embodiment” is used herein to mean “serving as an example, instance, or illustration.” Any embodiment described herein is not necessarily to be construed as preferred or advantageous over other embodiments. While the various aspects of the embodiments are presented in drawings, the drawings are not necessarily drawn to scale.

Additionally, reference throughout this specification to “an embodiment” or “the embodiment” means that a particular feature, structure or characteristic described in connection with that embodiment is included in at least one embodiment. Thus, the quoted phrases, or variations thereof, as recited throughout this specification are not necessarily all referring to the same embodiment.

Similarly, it should be appreciated that the above Detailed Description of Specific Embodiments includes the referenced figures and following claims, and is more simply referred to herein as the “description” or the “disclosure.” In this description, various features are sometimes grouped together in a single embodiment, figure, or written explanation thereof for the purpose of streamlining this disclosure. However, this method of disclosure is not to be interpreted as reflecting an intention that any claim require more features than those expressly recited in that claim. Rather, as the following claims reflect, inventive aspects lie in a combination of fewer than all features of any single foregoing disclosed embodiment. Thus, the claims following this description are hereby expressly incorporated into this description and disclosure, with each claim standing on its own as a separate embodiment. Additionally, this description includes all permutations of the independent claims with their dependent claims.

Also, the terms “substantially”, “proximate to”, and “approximately” or “approximate” are employed herein throughout, including this detailed description and the attached claims, with the understanding that is denotes a level of exactitude commensurate with the skill and precision typical for the particular field of endeavor, as applicable.

Additionally, the terminology used in this Detailed Description of Specific Embodiments is to be interpreted according to ordinary and customary usage in the field of the invention as exemplified in the pertinent U.S. and International Patent Classification Codes, and equivalent codes in other patent classification systems.

In compliance with the statutes, the invention has been described in language more or less specific as to structural features and process steps where applicable. While this invention is susceptible to embodiment in different forms, the specification illustrates preferred embodiments of the invention with the understanding that the present disclosure is to be considered an exemplification of the principles of the invention, and the disclosure is not intended to limit the invention to the particular embodiments described. Those with ordinary skill in the art will appreciate that other embodiments and variations of the invention are possible, which employ the same inventive concepts as described above. Therefore, the invention is not to be limited except by the following claims, as appropriately interpreted in accordance with the doctrine of equivalents.

What is claimed is:

1. A mobile hop harvester and processor apparatus comprising:
a mobile main chassis with a forward end and a rearward end, a first side located substantially in a parallel to a forward travel direction toward the forward end and a second side located substantially in a parallel to the forward travel direction, and a centerline located substantially in parallel to the forward travel direction at a mid-way between the first side and the second side;
a bine processing table supported on the mobile main chassis, and the bine processing table for receiving a bine of a hop plant from a trellis in a hop yard;
a cutting tower that extends upwardly from the mobile main chassis, the cutting tower tilt-able on a tower pivot, with the tower pivot located on the mobile main chassis, proximate to the forward end, and the cutting tower tilt-able on the tower pivot upward and toward the forward end in a tower raising movement about the tower pivot to raise the cutting tower up to a raised tower position with the cutting tower at the full height of the trellis in the hop yard in the raised tower position, and the cutting tower position-able proximate to a plant top of the hop plant;
the cutting tower having a multiple of cutters, the multiple of cutters including a top-beam cutter located proximate to an upper tower end of the cutting tower, a lower-beam cutter located proximate to a lowest portion of the cutting tower proximate to the tower pivot, and the cutting tower cuts the bines received into the bine processing table into a multiple of bine segments;
a retarder frame supported beneath the bine conveyor of the bine processing table, and the retarder frame the bine conveyor tilts on table pivot that is located proximate the forward end of the mobile main chassis;
the bine conveyor inclined upward to the rearward end of the mobile main chassis, with a lower bine conveyor end proximate to the forward end of the mobile main chassis and forward of the tower pivot, and the bine conveyor inclined upward to an upper bine conveyor end located proximate to the rearward end of the mobile main chassis and the retarder frame over a picking frame that sets upon the mobile main chassis, with the retarder frame including a multiple of retarder rollers and the picking frame including a multiple of picking rollers, and the retarder frame and the multiple of retarder rollers along with the picking frame and the multiple of picking rollers together comprise a picking array;
the multiple of bine segments produced by the cutting tower fall onto the bine conveyor, and the bine conveyor transports the multiple of bine segments upward and to the upper bine conveyor end to a bine conveyor discharge;
the bine conveyor discharges the multiple of bine segments into a bine picker infeed of the picking array, with the multiple of picking rollers positioned beneath the multiple of retarding rollers, and the multiple of bine segments travel between the picking rollers and the retarding rollers so that the hop cones are picked from the multiple of bine segments and fall downward out of the picking array; and
a residual debris retained between the retarding rollers and picking rollers, the residual debris substantially every element of the multiple of bine segments excluding the hop cones, and the residual debris ejected from the picking array between the picking roller and the retarding roller at a debris discharge located proximate to the forward end of the mobile main chassis.

2. The hop harvester of claim 1, further comprising:
a forward operator positioned proximate to the forward end of the mobile main chassis, and a rearward operator positioned proximate to the rearward end of the mobile main chassis;
the forward operator steers a pair of forward wheels and the rearward operator; and
the rearward operator controls the operational position of the cutting tower and operation of the bine conveyor and picking array.

3. The hop harvester of claim 1, further comprising:
a pair of outboard cutters utilized to cut each of the hop plants as encountered on the trellises of the hop yard proximate to the forward end of the mobile main chassis, with the pair of outboard cutters includes a first outboard cutter can be mounted proximate to the first side of the mobile main chassis near the forward end, the pair of outboard cutters includes a second outboard cutter mounted proximate to the second side of the mobile main chassis near the forward end, with each outboard cutter includes a spinning rotor blade mounted on an outboard blade motor, and with each outboard blade motor attached to an outboard arm that extends from an outboard cutter pivot attached to the main chassis proximate to the forward end of the mobile main chassis; and
an outboard cutter actuator connects the mobile main chassis and the outboard cutter arm, and the pair of outboard cutters individually positioned to sever the hop bine proximate to a plant base of the hop plant.

4. The mobile hop harvester and processor apparatus of claim 3, further comprising:
a forward operator positioned proximate to the forward end of the mobile main chassis, and a rearward operator positioned proximate to the rearward end of the mobile main chassis;
the forward operator steers a pair of forward wheels and the rearward operator;
the rearward operator controls the operational position of the cutting tower and operation of the bine conveyor and picking array; and
the pair of hop cutters are configured to process a side-by-side hop bine pair simultaneously, with a first hop bine cut and processed toward the first side of the mobile main chassis and a second hop bine cut and processed toward the second side of the hop harvester, and with a forward cab housing the forward operator positioned between the first cut hop bine and the second cut hop bine.

5. The mobile hop harvester and processor apparatus of claim 1, further comprising:
a bine auger positioned proximate to the upper tower end of the cutting tower and to the rearward of the top-beam cutter, with each string of the trellis of the hop yard tied to an overhead parallel wire that runs substantially parallel to the forward travel direction of the mobile main chassis, and substantially parallel to the overhead parallel wire;
the bine auger includes a spiraled attachment to the cutting tower received into the cutting tower inwardly and away from first side and the second side of the mobile main chassis, and toward the centerline of the mobile main chassis;
the bine auger directs the top wires with the attached bine segments on each trellis that hangs from the top wires, and the bine auger includes a first auger proximate to the first side of the mobile main chassis, the first auger rotates to pull the overhead parallel wire engaged within the first bine auger from the first side of the mobile main chassis toward the centerline of the hop harvester, and a second auger rotates to pull the overhead parallel wire engaged within the second auger away from the second side toward the centerline of the mobile main chassis;
the first auger and the second auger placed on an auger shaft that is common to the first auger and the second auger, with the first auger counter-spiraled in relation to the second auger; and
when the auger shaft of the bine auger is rotated, the first auger and the second auger rotate together to each pull the overhead parallel wire and push any of the multiple of bine segments attached to the overhead parallel wire away from the respective first outer side and second outer side and to the centerline of the mobile main chassis.

6. The mobile hop harvester and processor apparatus of claim 1, additionally wherein:
the cutting tower can be tilted downward to the rearward end of the mobile main chassis in a tower lowering movement about the tower pivot, to lower the cutting tower down to a stowed tower position; and
the cutting tower rests on the bine processing table in the stowed tower position.

7. The mobile hop harvester and processor apparatus of claim 1, further comprising a mid-beam cutter located proximate to a mid-point of the cutting tower, the mid-point of the cutting tower located approximately half-way between the upper tower end and the tower pivot.

8. The mobile hop harvester and processor apparatus of claim 1, additionally wherein the bine conveyor and the retarder frame bine processing table are raised and lowered on a table pivot, the table pivot located on the mobile main chassis, proximate to the forward end of the mobile main chassis.

9. A mobile hop harvester and processor apparatus comprising:
a mobile main chassis with a forward end and a rearward end, a first side located substantially in a parallel to the forward travel direction and a second side located substantially in a parallel to the forward travel direction, and a centerline located substantially in parallel to the forward travel direction at a mid-way between the first side and the second side;
a bine processing table supported on the mobile main chassis, and the bine processing table for receiving a bine of a hop plant from a trellis in a hop yard;
a cutting tower that extends upwardly from the mobile main chassis, the cutting tower tilt-able on a tower pivot, with the tower pivot located on the mobile main chassis, proximate to the forward end, and the cutting tower tilt-able on the tower pivot upward and toward the forward end in a tower raising movement about the tower pivot to raise the cutting tower up to a raised tower position with the cutting tower at the full height of the trellis in the hop yard in the raised tower position, and the cutting tower position-able proximate to a plant top of the hop plant;
the cutting tower having a multiple of cutters, the multiple of cutters including a top-beam cutter located proximate to an upper tower end of the cutting tower, a lower-beam cutter located proximate to a lowest portion of the cutting tower proximate to the tower pivot, and the cutting tower cuts the bines received into the bine processing table into a multiple of bine segments;
a retarder frame supported beneath the bine conveyor of the bine processing table, and the retarder frame the bine conveyor tilts on table pivot that is located proximate the forward end of the mobile main chassis;
the bine conveyor inclined upward to the rearward end of the mobile main chassis, with a lower bine conveyor end proximate to the forward end of the mobile main chassis and forward of the tower pivot, and the bine conveyor inclined upward to an upper bine conveyor end located proximate to the rearward end of the mobile main chassis and the retarder frame over a picking frame that sets upon the mobile main chassis, with the retarder frame including a multiple of retarder rollers and the picking frame including a multiple of picking rollers, and the retarder frame and the multiple of retarder rollers along with the picking frame and the multiple of picking rollers together comprise a picking array;
the multiple of bine segments produced by the cutting tower fall onto the bine conveyor, and the bine conveyor transports the multiple of bine segments upward and to the upper bine conveyor end to a bine conveyor discharge;
the bine conveyor discharges the multiple of bine segments into a bine picker infeed of the picking array, with the multiple of picking rollers positioned beneath the multiple of retarding rollers, and the multiple of bine segments travel between the picking rollers and the retarding rollers so that the hop cones are picked from the multiple of bine segments and fall downward out of the picking array;
a cone conveyor positioned beneath the picking array, and the hop cones picked from the multiple of bine segments by the picking array fall downward out of the picking array to the cone conveyor move the hop cones upward and to the rearward end of the mobile main chassis to a cone discharge; and
a residual debris retained between the retarding rollers and picking rollers, and the residual debris ejected from the picking array between the picking roller and the retarding roller at a debris discharge located proximate to the forward end of the mobile main chassis.

10. The hop harvester of claim 9, further comprising:
a forward operator positioned proximate to the forward end of the mobile main chassis, and a rearward operator positioned proximate to the rearward end of the mobile main chassis;
the forward operator steers a pair of forward wheels and the rearward operator; and
the rearward operator controls the operational position of the cutting tower and operation of the bine conveyor and picking array.

11. The hop harvester of claim 9, further comprising:
a pair of outboard cutters utilized to cut each of the hop plants as encountered on the trellises of the hop yard proximate to the forward end of the mobile main chassis, with the pair of outboard cutters includes a first outboard cutter can be mounted proximate to the first side of the mobile main chassis near the forward end, the pair of outboard cutters includes a second outboard cutter mounted proximate to the second side of the mobile main chassis near the forward end, with each outboard cutter includes a spinning rotor blade mounted on an outboard blade motor, and with each outboard blade motor attached to an outboard arm that extends from an outboard cutter pivot attached to the main chassis proximate to the forward end of the mobile main chassis; and
an outboard cutter actuator connects the mobile main chassis and the outboard cutter arm, and the pair of outboard cutters individually positioned to sever the hop bine proximate to a plant base of the hop plant.

12. The mobile hop harvester and processor apparatus of claim 11, further comprising:
a forward operator positioned proximate to the forward end of the mobile main chassis, and a rearward operator positioned proximate to the rearward end of the mobile main chassis;
the forward operator steers a pair of forward wheels and the rearward operator;
the rearward operator controls the operational position of the cutting tower and operation of the bine conveyor and picking array; and
the pair of hop cutters are configured to process a side-by-side hop bine pair simultaneously, with a first hop bine cut and processed toward the first side of the mobile main chassis and a second hop bine cut and processed toward the second side of the hop harvester, and with a forward cab housing the forward operator positioned between the first cut hop bine and the second cut hop bine.

13. The mobile hop harvester and processor apparatus of claim 9, further comprising:
a bine auger positioned proximate to the upper tower end of the cutting tower and to the rearward of the top-beam cutter, with each string of the trellis of the hop yard tied to an overhead parallel wire that runs substantially parallel to the forward travel direction of the mobile main chassis, and substantially parallel to the overhead parallel wire;
the bine auger includes a spiraled attachment to the cutting tower received into the cutting tower inwardly and away from first side and the second side of the mobile main chassis, and toward the centerline of the mobile main chassis;
the bine auger directs the top wires with the attached bine segments on each trellis that hangs from the top wires, and the bine auger includes a first auger proximate to the first side of the mobile main chassis, the first auger rotates to pull the overhead parallel wire engaged within the first bine auger from the first side of the mobile main chassis toward the centerline of the hop harvester, and a second auger rotates to pull the overhead parallel wire engaged within the second auger away from the second side toward the centerline of the mobile main chassis;
the first auger and the second auger placed on an auger shaft that is common to the first auger and the second auger, with the first auger counter-spiraled in relation to the second auger; and
when the auger shaft of the bine auger is rotated, the first auger and the second auger rotate together to each pull the overhead parallel wire and push any of the multiple of bine segments attached to the overhead parallel wire away from the respective first outer side and second outer side and to the centerline of the mobile main chassis.

14. The mobile hop harvester and processor apparatus of claim 9, additionally wherein:
the cutting tower can be tilted downward to the rearward end of the mobile main chassis in a tower lowering movement about the tower pivot, to lower the cutting tower down to a stowed tower position; and
the cutting tower rests on the bine processing table in the stowed tower position.

15. The mobile hop harvester and processor apparatus of claim 9, further comprising a mid-beam cutter located proximate to a mid-point of the cutting tower, the mid-point of the cutting tower located approximately half-way between the upper tower end and the tower pivot.

16. The mobile hop harvester and processor apparatus of claim 9, additionally wherein the bine conveyor and the retarder frame bine processing table are raised and lowered on a table pivot, the table pivot located on the mobile main chassis, proximate to the forward end of the mobile main chassis.
